(19) United States
(12) Patent Application Publication
(10) Pub. No.: US 2011/0079324 A1
(43) Pub. Date: Apr. 7, 2011

(54) Board edger with tandem saw boxes

(75) Inventors: Kenneth Appeldoorn, Salmon Arm (CA); Hugh Hawley, Keswick Ridge (CA); Stephen Mockler, Fredericton (CA)

(73) Assignee: McDonough Manufacturing, Eau Claire, WI (US)

(21) Appl. No.: 12/926,756

(22) Filed: Dec. 8, 2010

Related U.S. Application Data
(63) Continuation-in-part of application No. 11/688,428, filed on Mar. 20, 2007.

(51) Int. Cl. B27B 5/04; B27B 5/29

(52) U.S. Cl. 144/376; 83/563; 144/402

(57) ABSTRACT

The board edger has a longitudinal horizontal board path therein and first and second saw boxes disposed in a tandem mode adjacent the board path. Each saw box has a pair of saw blades mounted therein. The saw blades have a cutting direction that is aligned generally along the longitudinal board path. A controller is provided for coordinately moving the pair of saw blades in the first saw box into the board path for edging a first wood board and the pair of saw blades in the second saw box out of the board path for pre-positioning in view of edging a second wood board. One saw box is used for edging odd wood boards and the other saw box is used for edging even wood boards.

This is a Continuation-In-Part application of application Ser. No. 11/688,428 filed Mar. 20, 2007.

### FIELD OF THE INVENTION

This invention pertains to sawmill edgers and more particularly, it relates to a board edger having tandem saw boxes therein controlled by a scanner and a computer to increase efficiency in the edging of wood cants.

### BACKGROUND OF THE INVENTION

In the present specification, the words “wood piece”, “wood cant”, “wood board” are used interchangeably to designate a lengthwise strip of wood cut from a tree trunk. The word “edging” means sawing irregular edges along both longitudinal sides of a wood cant to obtain a piece of lumber with parallel sides and edges. The word “edger” designates a machine for edging.

Wood cants have irregular and non-parallel sides which make them difficult to physically align along the longitudinal axis of a conveyor for example. In lieu of mechanical positioning devices, modern sawmill equipment use lineal scanners and computers to precisely determine the position, and to measure the dimensions, of a wood cant moving on a conveyor. These scanners and computers generate three-dimensional images of the cant relative to the longitudinal axis of the edger, and calculate a sawing solution that represents the highest value combination of products which can be obtained from the cant.

Coincidently, sawmill edgers have been developed to operate with lineal scanners and computers. These edgers each have a saw box that is adjustable about a vertical axis and saw blades that are movable sideways along the arbor. The positions of the saw blades are continuously guided to track the realtime position and alignment of a wood board being fed there through and to follow an optimized cutting profile defined by the computer.

Examples of optimized edgers and related sawmill machinery available in the prior art are disclosed in the following documents; U.S. Pat. No. 4,239,072 issued Dec. 16, 1980 to H. Meriläinen; U.S. Pat. No. 5,373,878 issued Dec. 20, 1994 to J. D. Walker; U.S. Pat. No. 5,722,474 issued Mar. 3, 1998 to C. Raybon et al.; U.S. Pat. No. 5,816,302 issued Oct. 6, 1998 to W. R. Newnes; U.S. Pat. No. 5,884,682 issued Mar. 23, 1999 to J. B. Kennedy et al.; U.S. Pat. No. 5,946,995 issued Sep. 7, 1999 to S. W. Michell et al.; U.S. Pat. No. 6,178,858 issued Jan. 30, 2001 to M. P. Knerr et al.; U.S. Pat. No. 6,202,526 issued Mar. 20, 2001 to M. Dockter et al.; U.S. Pat. No. 6,305,259 issued Oct. 23, 2001 to R. Whitworth et al.; U.S. Pat. No. 6,393,956 issued May 28, 2002 to S. Blum et al.; U.S. Pat. No. 6,644,164 issued Nov. 11, 2003 to B. T. Stroud; U.S. Pat. No. 6,929,043 issued Aug. 16, 2005 to J. D. Woodford et al.;

It will be appreciated that in a continuous wood edging process, the cants to be trimmed must be spaced apart lengthwise through the edger such that the saw blades can track the optimized cut lines in one cant and reposition quickly to track the optimized cut lines in a next cant.

In one example of a board edger of the prior art, U.S. Pat. No. 6,929,043, also identified hereinafter as the Woodford edger, describes an optimized board edger wherein the spacing and alignment of the saw blades follow optimized cut lines on a virtual entity of the wood board to be trimmed. The virtual entity is superimposed over the actual wood board and is moved with the wood board. The virtual entity is longer than the wood board such that any milling and aftercut on the leading and trailing edges of the wood board are eliminated.

In this method of the prior art, the spacing between cants and the speed of the upstream conveyor are limited by the response time of the computer to calculate a sawing solution and by the response time of the actuators to reposition the saw box between cants. Because of the variations in optimized profiles and positioning from one wood cant to the next, and because of the inertia of high-production saw boxes, the sawmill industry is at a stand still in regards to the processing speed of edgers. As such, it may be appreciated that there continues to be a need for an improved method and machinery to operate a board edger with more efficiency.

### SUMMARY OF THE INVENTION

In the present invention, however, there is provided an optimized board edger with tandem saw boxes. The two saw boxes alternate to cut the odd and even boards being fed to the edger. The pre-setting of one saw box is effected while the other saw box is sawing. Because of this arrangement, a reduction is spacing between boards and an increased processing speed are obtained.

In one aspect of the present invention, there is provided a method of edging wood boards in series comprising; sequentially moving first and second wood boards lengthwise along and into a longitudinal horizontal board path; moving a first pair of saw blades into the board path and edging the first wood board; moving the first pair of saw blades away from the board path and moving a second pair of saw blades into the board path and edging the second wood board.

In another aspect of the present invention, the method further includes the steps of scanning the first and second wood boards and the step of edging comprises the step of edging the first and second wood boards along optimized profiles of the first and second wood boards.

In yet another aspect of the present invention, there is provided a board edger having a longitudinal horizontal board path therein. The edger has first and second saw boxes disposed in a tandem mode adjacent the board path. Each of the saw boxes has at least a pair of saw blades mounted therein. The saw blades have a cutting direction that is aligned generally along the longitudinal board path. A controller is provided for coordinately moving the pair of saw blades in the first saw box into the board path and the pair of saw blades in the second saw box out of the board path, when the pair of saw blades in the first saw box is moved into the board path.

In yet another aspect of the present invention, there is provided an installation for edging wood boards. This installation has a conveyor system for transporting wood boards thereon and a scanner and computer associated with the conveyor system for scanning and optimizing saw cuts on wood boards transported on the conveyor system. This installation also has a board edger associated with the conveyor system. The edger has a longitudinal horizontal board path therein and first and second saw boxes disposed adjacent the board path. Each of the saw boxes has at least one pair of saw blades mounted therein. The saw blades have a cutting direction that is aligned generally along the longitudinal board path. This installation further has a controller for cooperatively moving the pair of saw blades in the first saw box into the board path and the pair of saw blades in the second saw box out of the board path when the pair of saw blades in the first saw box is moved into the board path, and for cooperatively moving the pair of saw blades in the first saw box out of the board path and the pair of saw blades in the second saw box into the board path when the pair of saw blades in the first saw box is moved out of the board path. There is also provided means for guiding the saw blades along optimized profiles defined by the scanner and the computer.

The thickness of the board path in the edger according to the present invention is relatively small. The distance travelled by the saw blades in each saw box between a cutting position into the board path and a pre-setting position out of the board path, is also relatively small. Because of this relatively short distance across the board path, the longitudinal spacing between wood board being fed to the edger is only dependent on the time that it takes to move saw blades in and out of the board path. The spacing between wood board is no longer dependent on the time that it takes to calculate a cutting solution or the time that it takes for the controller to adjust the saw spacing and orientation. A substantial increase in production is thereby achieved.

The person skilled in the art will also understand that when the wood boards that are fed to the edger according to the present invention are skewed on the infeed conveyor, the edger can accept boards where the leading end of one board lays to the side of the trailing end of the previous board.

Other advantages and novel features of the present invention will become apparent from the following detailed description of the preferred embodiment.

### BRIEF DESCRIPTION OF THE DRAWINGS

In order to facilitate the description of the present invention without the need of having recourse to other document, several drawings are provided herein to describe an optimized board edger of the prior art. Then, four embodiments of the present invention are illustrated. In the drawings;

FIG. 1 is a plan view of a board edging installation of the prior art comprising an optimized board edger;

FIG. 2 is an enlarged plan view of the optimized board edger of the prior art and partial views of the upstream transport conveyor and downstream discharge conveyor;

FIG. 3 is an enlarged plan view of the saw box in the optimized board edger of the prior art;

FIG. 4 is a cross-section view of the saw box, as seen along line 4-4 in FIG. 3;

FIG. 5 is a side view of the saw box in FIG. 4;

FIG. 6 is a perspective exploded view of a saw blade, a saw collar assembly and a saw shifting arm comprised in the saw box in the optimized board edger of the prior art;

FIG. 7 is a plan view of a board edging installation comprising the board edger with tandem saw boxes according to the first preferred embodiment of the present invention;

FIG. 8 is an enlarged plan view of the board edger with tandem saw boxes according to the first preferred embodiment of the present invention shown with partial views of the upstream and downstream conveyors;

FIG. 9 is a schematic side elevation view, with the side plate removed, of the board edger with tandem saw boxes according to the first preferred embodiment of the present invention;

FIG. 10 is a second schematic side elevation view, with the side plate removed, of a board edger with tandem saw boxes according to a second preferred embodiment of the present invention;

FIG. 11 is a third schematic side elevation view, with the side plate removed, of a board edger with tandem saw boxes according to a third preferred embodiment of the present invention;

FIG. 12 is a fourth schematic plan view of a board edger with tandem saw boxes, according to a fourth preferred embodiment of the present invention.

### DESCRIPTION OF PREFERRED EMBODIMENTS

A) Brief Description of Wood Edging in the Prior Art

Several drawings are included herein to describe the Woodford edger as a typical example of machines of the prior art. These drawings and the following description are provided herein to facilitate the understanding of the present invention without having to refer to other document incorporated by reference.

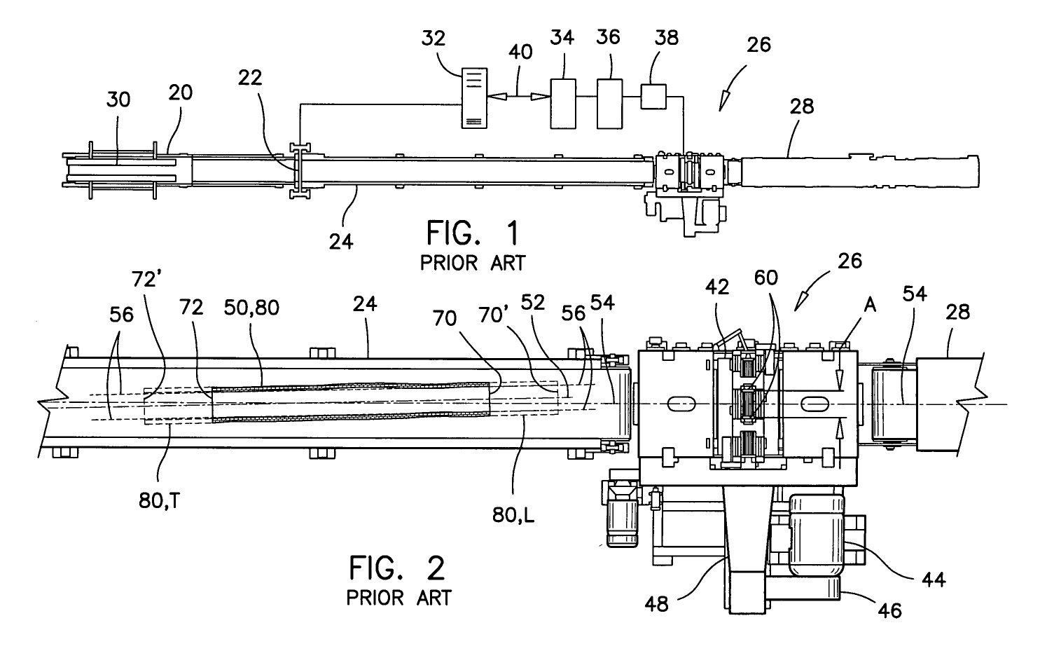

Referring firstly to FIGS. 1-2, a method for operating a board edger of the prior art will be described. The board edging installation comprises an in-line arrangement of an upstream conveyor 20, a lineal scanner 22, a transport conveyor 24, a board edger 26, and a discharge or downstream conveyor 28. The preferred infeed conveyor 20 has a board pre-locating device 30 which function is to position each board as straight as possible along the transport conveyor 24. The infeed conveyor 20 can be fed manually or from a sorting table as it is customary in sawmills.

In this board edging installation of the prior art, a computer system is provided between the lineal scanner 22 and the board edger 26. This computer system comprises a personal computer (PC) 32 containing an optimizing software, a programmable logic controller (PLC) 34 communicating with the PC 32 and with one or more servo modules 36 and one or more servo drive translators 38 to control the tracking functions of the board edger 26. A two-way ethernet connection 40 is provided between the PC 32 and the PLC 34.

The length of the transport conveyor 24 is determined according to the desired travel speed of wood cants on this transport conveyor and the processing time for each sawing solution.

The board edger 26 of the prior art has one active saw box 42 which is movable about a vertical axis and in which the saw blades are movable along the arbor. In order to reduce the inertia of the saw box 42, the arbor is driven by an electric motor 44 through sheaves and belts under the guard 46 and a flexible drive shaft under the guard 48.

In use, an untrimmed wood board 50 is scanned while in motion through the scanner 22. The longitudinal axis 52 of the board relative to the longitudinal axis 54 of the board edger, as well as the optimized cut lines 56 are determined while the wood board 50 is moving toward the board edger 26.

The saw blades are set apart a same distance A as the spacing between the optimized cut lines 56. The saw box 42 is rotated to align the saw blades 60 parallel with the longitudinal axis 52 of the wood board, and the saw blades are set in motion along the arbor 62. The saw blades 60 are spaced and guided to follow the optimized cut lines 56 as the wood board 50 travels through the board edger 26.

When the longitudinal axis 52 of a wood board 50 to be trimmed is skewed a few degrees from the feeding direction 54, it will be appreciated that an initial adjustment to a proper spacing and alignment of the saw blades 60 must be made before the saw blades enter the wood piece. As the saw blades 60 enter the wood piece 50, the saw blades 60 must be guided to move in unison along the arbor 62 to follow the optimized cut lines 56.

In the method of operating the board edger 26 of the prior art, the PC 32 is configured to construct a virtual entity 80 of each wood board 50. This virtual entity 80 has all the dimensions of the physical wood board 50. This virtual entity 80 is superimposed in space and time over the physical wood board 50.

Depending upon the operating speed and the length of the transport conveyor 24, the virtual entity 80 is assigned excess length L ahead of the leading edge 70 of the wood board 50, and excess length T following the trailing edge 72 of the wood board 50. The optimized cut lines 56 are projected along both excess lengths L, T.

In the method of operation, the angle of the saw blades 60 relative to the longitudinal axis 52 of the wood board 50 and the spacing A of the saw blades 60 are adjusted, and the displacement of the saw blades in unison along the arbour 32 is set in motion by the PC 32 according to the position, alignment and travelling speed of the virtual entity 80. The target set points between which precise tracking of the saw blades 60 is maintained are set at the forward edge 70′ and the rear edge 72′ of the virtual entity 80. By aiming the saw blades 60 at the forward edge 70′ of the virtual entity 80, the inherent oscillation of the saw blades 60 during positioning occurs along the excess length L, such that uniform side edges are obtained from the leading edge 70 of the actual wood board 50. Similarly, the tracking of the optimized cut lines are maintained up to the rear edge 72′ of the virtual entity 80 to ensure that the saw blades are out of the wood board 50 when tracking stops.

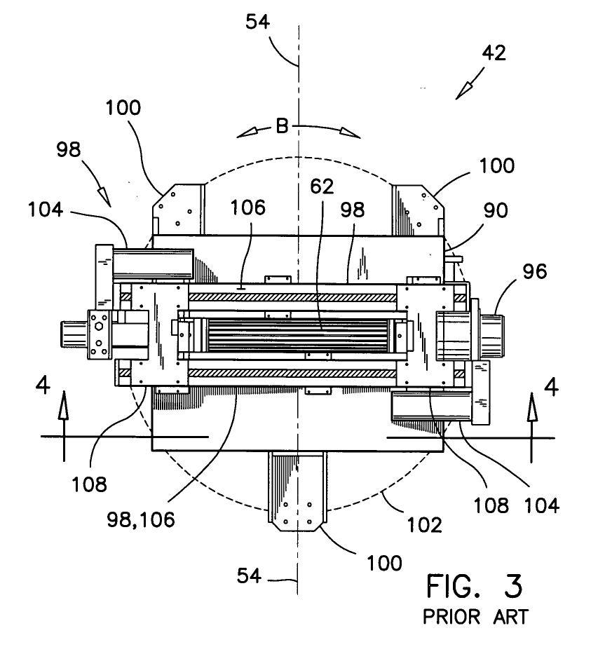

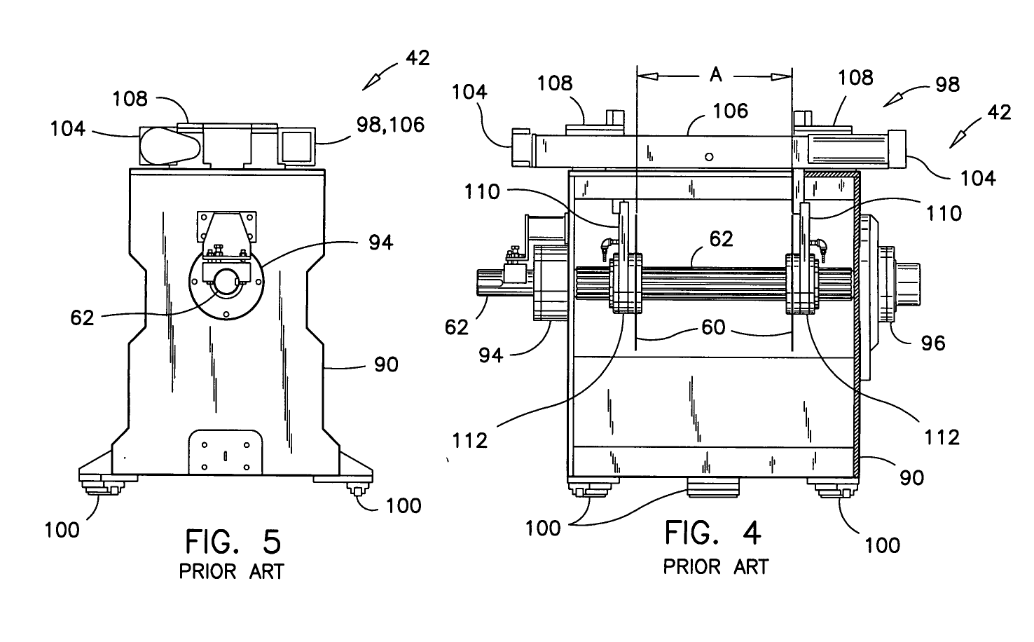

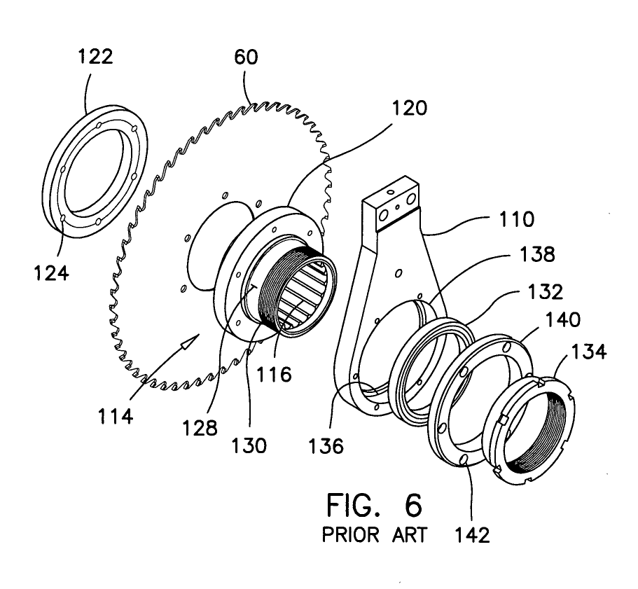

Referring now to FIGS. 3-5, the saw box 42 in the edger 26 of the prior art will be described in some details. The saw box consists of a frame 90, an arbor 62 mounted in bearings 94, 96, a pair of saw blades 60 mounted on the arbor 62. The saw box has a setworks 98 mounted on top of the frame 90. There is provided three circular ball bearings 100 on the bottom of the frame 90. The bearings 100 are set on a circular rail 102, represented by a dashed line in FIG. 3. This circular rail is mounted on the base of the edger 26. The preferred angular adjustment B of the saw box 42 is 7½° to the left and to the right of the longitudinal axis 54 of the optimized board edger 26, for a total angular displacement of 15°.

The rotation of the saw box 42 to the right or the left of the longitudinal axis 54 is effected by a DC servo drive actuator controlled by the PC 32. This DC servo drive actuator and its mounting have not been illustrated herein for being known to those skilled in the art.

The setworks 98 also comprises two DC servo drive motors 104 respectively linked to a linear slide 106, and also being controlled by the PC 32. Each linear slide 106 encloses a ball screw and a ball nut connected to a yoke plate 108. Each DC servo drive motor 104 drives the yoke plate 108 along the linear slide 106 with precision. A shifting arm 110 is affixed to the yoke plate 108 and extends to a respective saw collar assembly 112 for moving one of the saw blades 60 along the arbor 62. Both saw blades 60 are movable independently of each other along the arbor 62 for board width adjustment, and in unison with each other during the edging of a wood board.

The arbor 62 has splines thereon as it is customary with board edgers. Each saw blade 60 is supported in a collar assembly 112, which is adapted to engage with, and to slide along these splines. This collar assembly 112 is better illustrated in FIG. 6. The saw collar assembly 112 comprises a hub 114 which has grooves 116 therein to engage with the splines on the arbor 62, with a loose sliding fit. The hub 114 has a flange 120 on its circumference, to which is clamped the saw blade 60, by means of a blade lock ring 122 with bolt holes 124 and machine screws through these holes.

Next to the flange 120, there is an inner bearing seat 128 on the outside surface of the hub, and an adjoining threaded portion 130. A bearing 132 is held to the inner bearing seat 128 of the hub by a lock nut 134 engaged over the threaded portion 130. This bearing 132 affords a frictionless rotation of the hub 114 relative to the shifting arm 110.

The outer race of the bearing 132 is clamped into an outer bearing seat 136 inside an opening 138 in the lower end of the shifting arm 110. The outer race of the bearing 132 is held to the outer bearing seat 136 by means of an outer lock ring 140 having bolt holes 142 and machine screws through these holes. Where possible, the components of the saw collar assembly 112 are made of aluminum to ensure a minimum weight and inertia.

B) Preferred Embodiments of the Present Invention

While this invention is susceptible of embodiment in many different forms, there is shown in the drawings and will be described in details herein four preferred embodiments of the board edger with tandem saw boxes according to the present invention, with the understanding that the present disclosure is to be considered as an example of the principles of the invention and is not intended to limit the invention to the embodiments illustrated and described.

In the preferred embodiments of the present invention, the saw blades, the saw arbors, the shifting arms and the setworks, drive motors and the drive shafts are the same as or similar to those described in the Woodford edger. Similarly, the scanner, the upstream and downstream conveyors, the saw box controllers are basically the same as those used in the Woodford edger. Furthermore, the skewing of saw boxes, the tracking of optimized cut lines, the spacing and guiding of the saw blades may be done in same or similar ways as described in the Woodford edger.

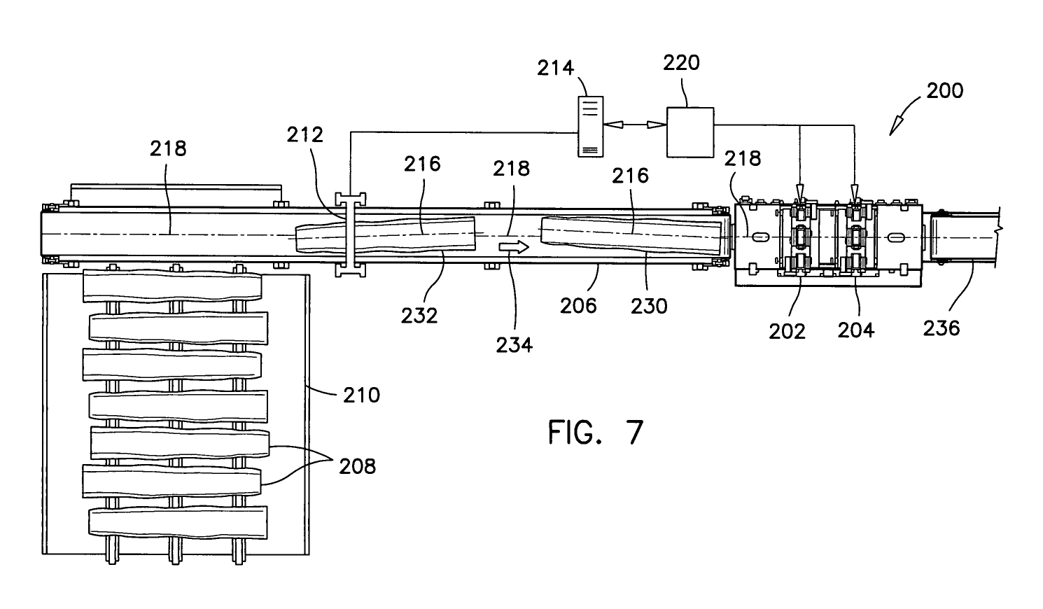

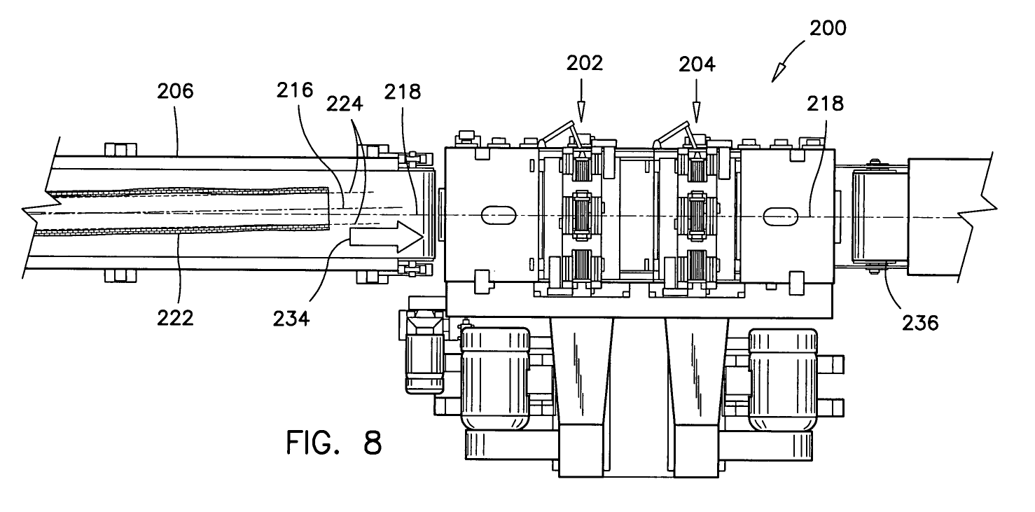

Referring to FIGS. 7 and 8, the preferred installation comprises a board edger 200 that has two saw boxes 202, 204 mounted therein in a tandem mode. Wood cants 208 are fed in series to the board edger 200 along a transport conveyor 206. Wood cants 208 may be fed from a feed table 210 as illustrated in FIG. 7. No further detail is provided for the transport conveyor 206 and the feed table 210 because these equipment are well known in the field of sawmill machinery.

A scanner 212 is mounted between the feed table 210 and the edger 200, preferably over the transport conveyor 206. The scanner 212 generates an image of each wood cant passing there under. These images contain data related to the orientation and profile of each cant. These images are fed to a computer 214 which determine the longitudinal axis 216 of each cant relative to the longitudinal axis 218 of the board edger 200.

The data related to the profile of each board, label 222 in FIG. 8 for example, is analysed by the computer 214 to determine an optimum cutting solution to obtain a maximum amount of lumber from the wood board 222.

The computer 214 generates instructions to the saw controller 220 to set the orientation of one of the saw boxes and the spacing of the saw blades in that saw box to cut that wood cant along optimum cutting lines 224 for example, to obtain a maximum amount of lumber from the wood cant.

Referring back to FIG. 7, one feature in the board edger 200 with tandem saw boxes according to the first embodiment of the present invention is that the first saw box 202 for example is set to cut the first wood cant 230 and the second saw box 204 is set to cut the second wood cant 232 being fed to the board edger 200. While the first saw box 202 is cutting the first wood cant 230, the second saw box 204 is being pre-set to saw the second wood cant 232. As soon as the first cant 230 is cut, the saw blades in the first saw box 202 are moved away from the board path 270 and the saw blades in the second saw box 204 are moved into the board path 270. While the second wood cant 232 is being cut, the first saw box 202 is pre-set to saw the third wood cant, and so on. One saw box 202 is set to cut the odd wood cants and the other saw box 204 is set to cut the even wood cants.

The arrow 234 in the drawings indicate a direction of movement of the wood cants toward the board edger 200 during operation of the board edger 200.

The longitudinal axis 218 of the board edger 200 indicates, generally, a direction of cutting of the saw blades in the saw boxes in all preferred embodiments, with slight angular variations from the axis 218 to track optimum cut lines on wood boards.

Trimmed board are carried away from the board edger 200 on a downstream conveyor 236.

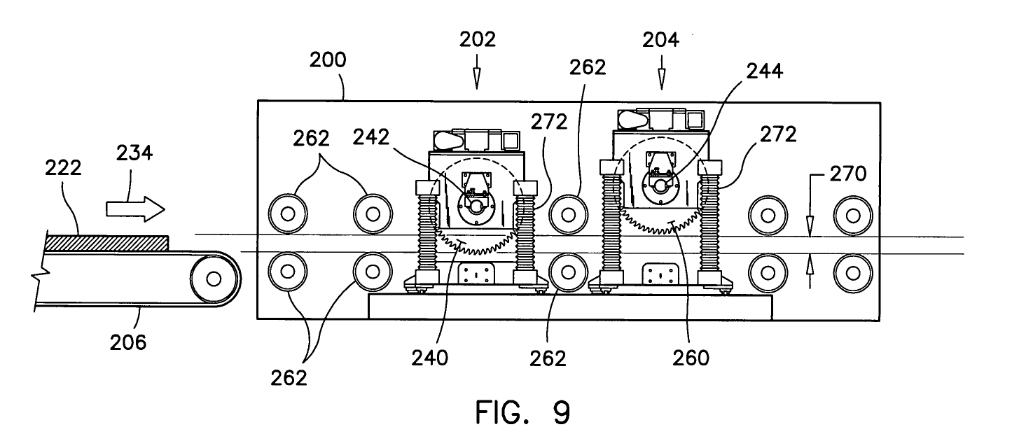

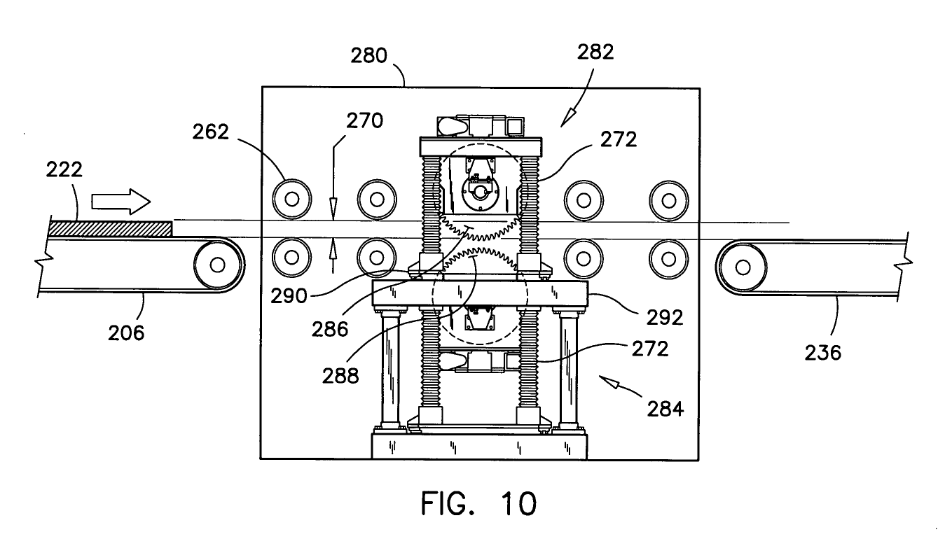

Referring now to FIG. 9, there is illustrated therein one arrangement for moving the saw blades 240, 260 of the first and second saw boxes 202, 204 respectively, in and out of the board path 270. In the embodiment illustrated, the saw arbors 242, 244 are moved up and down by linear actuators 272, or other equivalent mechanisms.

It will be appreciated that when one saw box is cutting one wood board, the saw blades 260 of the other saw box 204 are out of the board path 270. It will also be appreciated that any pre-positioning of the saw blades 240, 260 and the orientation of the saw boxes 202, 204 are effected when the saw blades of that particular saw box are out of the board path 270.

For clarity, the vertical spacing in which wood cants are moving through the edger 200, or the vertical gap of the edger between the guide rolls 262 of the edger 200, and a horizontal projection of this gap is referred to herein as the board path 270. The saw blades in each saw box move vertically in and out of this board path 270 for edging wood cants.

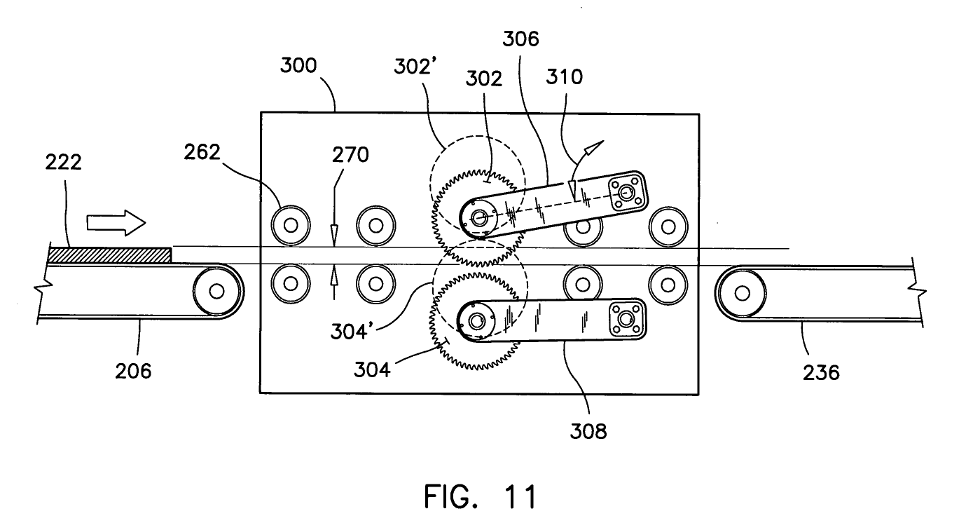

In the second preferred embodiment 280 of the present invention, as illustrated in FIG. 10, both saw boxes 282, 284 are mounted on top of each other, with their respective saw blades 286, 288 being movable in and out of the board path 270. In this second embodiment, the saw boxes are moved up and down relative to the horizontal board path 270, in and out of the board path 270, by means of linear actuators 272 or similar mechanism. In this embodiment, the top saw box 282 is supported on a rotating base 290 which is supported above the lower saw box 284 by a structural frame 292.

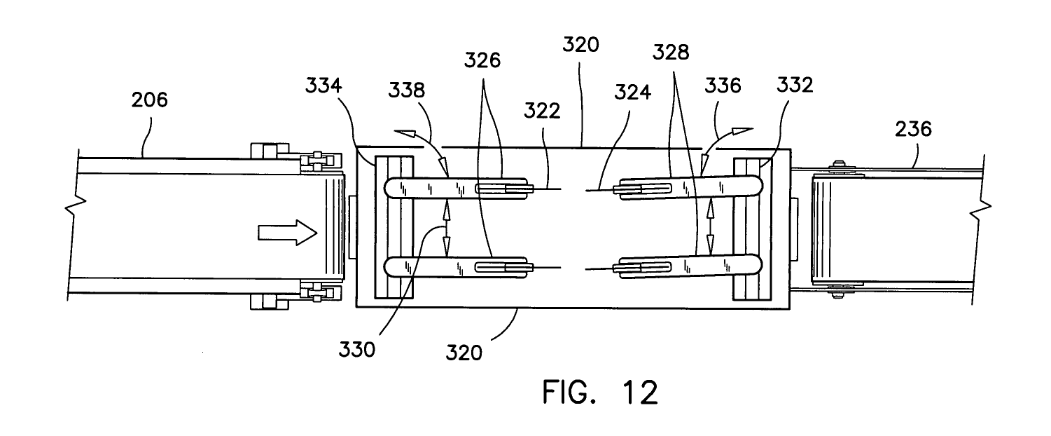

A third preferred embodiment 300 is illustrated in FIG. 11. In this third embodiment 300, pairs of saw blades 302, 304 are mounted on arms 306, 308 respectively with one pair of saw blades mounted above the board path 270 and another pair mounted below the board path. The arms 306, 308 are movable up and down as shown by arrow 310 to raise and to lower the saw blades to alternate positions as shown by dashed-line circles 302′ and 304′. It will be appreciated that both arms are movable sideways on slides or otherwise (not shown) to adjust the saw blades 302, 304 transversely, to follow the optimum cut lines.

The fourth preferred embodiment 320 of the present invention is shown in FIG. 12. Pairs of saw blades 322, 324 are mounted on arms 326, 328 respectively. The arms 326, 328 are movable sideways along arrow 330 along slide 332, and 334 respectively. The arms 326, 328 are also movable angularly on the slides in directions indicated by arrows 336 and 338 to follow optimum cut lines.

There is also provided vertical actuators (not shown)on the arms 326, 328 to move the saw blades in and out of their cutting positions in the board path 270.

For the various embodiments taught therein above, it is also contemplated that different saw blades sizes may be used and that the machine geometry may be adjusted to accommodate these different saw blades sizes and different wood pieces to be sawn. Similarly, the elements shown in one embodiment may be combined to the elements in another embodiment according to the choice of the designer.

Therefore, the above description and the illustrations should not be construed as limiting the scope of the invention which is defined by the appended claims.

We claim:

1. A method of edging wood boards in series comprising;
sequentially moving first and second wood boards lengthwise along a longitudinal board path;
moving a first pair of saw blades into said board path and edging said first wood board;
moving said first pair of saw blades away from said board path and moving a second pair of saw blades into said board path and edging said second wood board.

2. The method as claimed in claim 1, further including the step of scanning said first and second wood boards and said steps of edging comprises the step of edging said first and second wood boards along optimized profiles of said first and second wood boards.

3. The method as claimed in claim 1, wherein said steps of moving said first and second pair of saw blades, comprise the steps of moving said first and second pairs of saw blades down and up respectively relative to said board path.

4. The method as claimed in claim 1, further including the step of adjusting spacing and orientation of said saw blades in said second pair of said saw blades prior to said step of moving said second pair of saw blades into said board path.

5. A board edger comprising:
a longitudinal horizontal board path therein;
first and second saw boxes disposed adjacent said board path; each of said saw boxes having at least a pair of saw blades mounted therein; each of said saw blades having a direction of cutting aligned generally along said board path;
a controller for coordinately moving said pair of saw blades in said first saw box into said board path and said pair of saw blades in said second saw box out of said board path when said pair of saw blades in said first saw box is moved into said board path.

6. The board edger as claimed in claim 5, wherein said controller further comprises means for coordinately moving said pair of saw blades in said first saw box out of said board path and said pair of saw blades in said second saw box into said board path when said pair of saw blade in said first saw box is moved out of said board path.

7. The board edger as claimed in claim 5, wherein said controller and said saw boxes have means for guiding said saw blades along optimized cut lines.

8. The board edger as claimed in claim 5, having a vertical gap and said longitudinal board path has a thickness of said gap.

9. The board edger as claimed in claim 7, wherein said controller and said saw boxes further have means for spacing said saw blades when said saw blades are out of said board path.

10. The board edger as claimed in claim 6, further comprising a conveyor for moving wood boards sequentially along said board path.

11. The board edger as claimed in claim 6, wherein said first and second saw boxes are mounted in a tandem mode along said board path.

12. The board edger as claimed in a claim 6, wherein said second saw box is mounted below said first saw box.

13. The board edger as claimed in a claim 12, wherein said second saw box is mounted below said first saw box and said board path.

14. An installation for edging wood boards:
a conveyor system for transporting wood boards thereon;
a scanner and computer associated with said conveyor system for scanning and optimizing saw cuts on wood boards transported on said conveyor system;
a board edger associated with said conveyor system and having;
a longitudinal horizontal board path therein;
first and second saw boxes disposed adjacent said board path; each of said saw boxes having at least a pair of saw blades mounted therein; each of said saw blades having a direction of cutting aligned generally along said board path;
a controller for cooperatively moving said pair of saw blades in said first saw box into said board path and said pair of saw blades in said second saw box out of said saw path when said pair of saw blades in said first saw box is moved into of said board path, and for cooperatively moving said pair of saw blades in said first saw box out of said board path and said pair of saw blades in said second saw box into said board path when said pair of saw blades in said first saw box is moved out of said board path, and
means for guiding said saw blades along optimized profiles defined by said scanner and computer.

15. The installation as claimed in claim 14, wherein said first and second saw boxes are spaced apart along said board path.

16. The installation as claimed in claim 14, wherein said first and second saw boxes are spaced apart above and below said board path respectively.

17. The installation as claimed in claim 14, wherein said means for guiding said saw blades has means for spacing said saw blades when said saw blades are out of said board path.

18. The installation as claimed in claim 14, wherein said edger has a vertical gap and said board path has a thickness of said gap.

19. The installation as claimed in a claim 16, wherein said second saw box is mounted below said first saw box.

20. The installation as claimed in a claim 19, wherein said second saw box is mounted below said first saw box and said board path.
